(19) United States
(12) Patent Application Publication
(10) Pub. No.: US 2009/0062469 A1
(43) Pub. Date: Mar. 5, 2009

(54) Method of making an adhesive

(76) Inventor: Cheng-Hsin Tsai, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/019,637

(22) Filed: Jan. 25, 2008

(30) Foreign Application Priority Data
Sep. 5, 2007 (TW) 096133067

(51) Int. Cl. C08G 63/00

(52) U.S. Cl. 525/61

(57) ABSTRACT

A method of making an adhesive is disclosed. The method includes steps of providing a polyvinyl alcohol (PVA) solution in water or a hydrophilic solvent and adding a metal-containing oxidant (such as potassium permanganate) to the PVA solution and allowing the metal-containing oxidant to react under stirring. The metal ion produced in the reaction may bond to the resulting 1,3-diketone structure of the PVA molecular chain to crosslink the PVA molecular chains without adding a crosslinking agent additionally.

### BACKGROUND OF THE INVENTION

1. Field of the Invention

The present invention relates to a method of making an adhesive, and particularly to a method of making an adhesive using PVA (polyvinyl alcohol) as a raw material.

2. Description of the Prior Art

A PVA polymer is generally made through polymerizing a vinyl ester monomer to form a polyvinyl ester and hydrolyzing the polyvinyl ester. PVA may be used for making adhesives. For example, it may serve as a “hydrogel” in a polarizing sheet manufacturing process or it may be incorporated with other ingredients to serve as adhesives for woodworking. To further improve physical properties, such as adhesive strength or water resistance, of such adhesives, a hydroxyl-reactive crosslinking agent is usually added in the process of making adhesives to develop a three dimensional network structure among PVA molecules, so as to improve bonding strength of the adhesives. Alternatively, a hydroxyl-reactive crosslinking agent is added to react with the monomers (such as vinyl acetate) used for polymerization, such that the PVA molecular chain is modified to have a three dimensional structure similar to the aforesaid one. Alternatively, the hydroxyl groups on the PVA molecular chains may be converted into other reactive functional groups, such as acetoacetyl group, by a reaction process. An acetoacetyl group has a 1,3-diketone structure and is highly reactive. FIG. 1 shows a modified PVA molecular chain having hydroxyl groups, acetyl groups due to incomplete hydrolysis, and acetoacetyl groups due to modification. The symbols m, n, and I each represent a positive integer in a conventional range.

The acetoacetyl group, CH₃(CO)CH₂(CO)O—, exhibits keto-enol tautomerism due to the 1,3-diketone structure. Accordingly, the carbon atom of the methylene group, the carbonyl oxygen atoms, and the carbonyl carbon atoms may react with various types of crosslinking agents to generate various types of bonding between the PVA molecular chains and form a three dimensional structure. FIG. 2 shows the structure of an acetoacetyl group and various types of crosslinking agents reactive thereto, as well as the reaction types. As shown in FIG. 2, acetoacetyl groups may react with dialdehydes, diamines, polyols, or metal ions (M) through covalent bonds or electric force to form a network structure among PVA molecules. R represents a substituted or unsubstituted alkylene group. Other examples of acetoacetyl-reactive crosslinking agents include adipic acid dihydrazide and polymers having a plurality of amino groups, hydroxyl groups, or aldehyde groups.

U.S. Pat. No. 5,569,703 discloses an adhesive comprising an aqueous emulsion of a copolymer containing an ethylene unit (A), a vinyl ester unit (B), and an acetoacetyl group-containing copolymerizable monomer unit (C) in a weight ratio of (A)/(B)/(C)=(5 to 70)/100/(0.1 to 10). The water resistance of the polymer can be adjusted by controlling the relative ratio and/or amount of each component. However, although the physical properties of the copolymer can be adjusted by controlling the relative ratio and/or amounts of the co-monomer units in such method, the physical properties of the polymer cannot be adjusted once the polymerization is completed. In other words, the properties and/or reactivity are already determined in accordance with the amount of the acetoacetyl group-containing copolymerizable monomer and cannot be further modified. Accordingly, such polymer is only suitable for certain adhesive uses, not suitable for use in various types of adhesives.

JP-A-57-202364 discloses a method, in which PVA is allowed to react with diketene to transform a part of the hydroxyl groups into acetoacetyl groups. FIG. 3 shows a reaction of PVA and diketene to form acetoacetylated PVA, wherein n is a positive integer in a conventional range. However, although the amount of the acetoacetyl groups of PVA molecular chains can be adjusted by the amount of diketene, the product is only a modified PVA molecular chain. In other words, a crosslinking agent is still additionally used to further improve the adhesion properties of the PVA adhesive.

The molecular chain of PVA polymers typically has a repeated unit, —CH₂CHOH—. In other words, the hydroxyl groups of two adjacent units form a 1,3-dihydroxyl structure. EP 1,263,802 mentions treating PVA with a NaIO₄—KMnO₄ reagent. This reagent is used for dividing PVA polymers into small PVA molecules with a molecular weight from 2000 to 4000, but not for oxidizing the hydroxyl groups on the PVA polymers to form a ketone group.

There is still a need for the study of novel methods of making adhesives to make adhesives (hydrogels) having high water resistance and adhesive strength, especially for use in polarizing sheet manufacturing processes.

### SUMMARY OF THE INVENTION

Accordingly, one objective of the present invention is to provide a novel method of making an adhesive, in which a three dimensional structure of the PVA molecules can be generated by oxidizing the 1,3-dihydroxyl structures in the PVA molecular chains to form 1,3-diketone structures without using additional crosslinking agents, thereby to improve physical properties, such as water resistance and adhesive strength, of the PVA adhesives.

The method of making an adhesive according to the present invention includes steps as follows. First, a PVA solution in water or a hydrophilic solvent is provided. Thereafter, potassium permanganate is added to the PVA solution and allowed to react in a reaction under stirring.

In another aspect of the present invention, the method of making an adhesive according to the present invention includes steps as follows. First, a PVA solution in water or a hydrophilic solvent is provided. Thereafter, a metal-containing oxidant is added to the PVA solution and allowed to react in a reaction under stirring, wherein the metal-containing oxidant produces the metal ion in the reaction.

In comparison with the conventional technique, in the method of making an adhesive according to the present invention, 1,3-dihydroxyl groups on the PVA molecular chains are oxidized to form 1,3-diketone structures using a metal-containing oxidant (such as potassium permanganate), and ions of the metal (such as manganous ion) produced from the reaction of the oxidant can be combined (such as chelated) with the 1,3-diketone structures formed on the PVA molecular chains to crosslink the PVA molecular chains. Accordingly, the PVA polymer can be crosslinked without using additional crosslinking agents.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a modified PVA molecular chain;

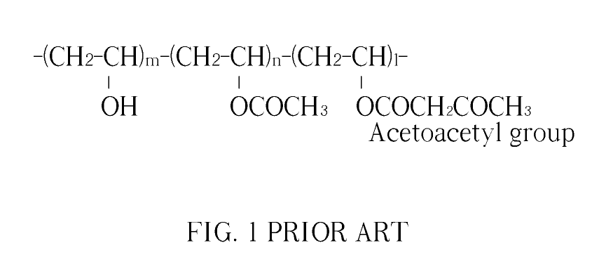

FIG. 2 shows a structure of an acetoacetyl group, various reactive crosslinking agents, and the reaction types of them;

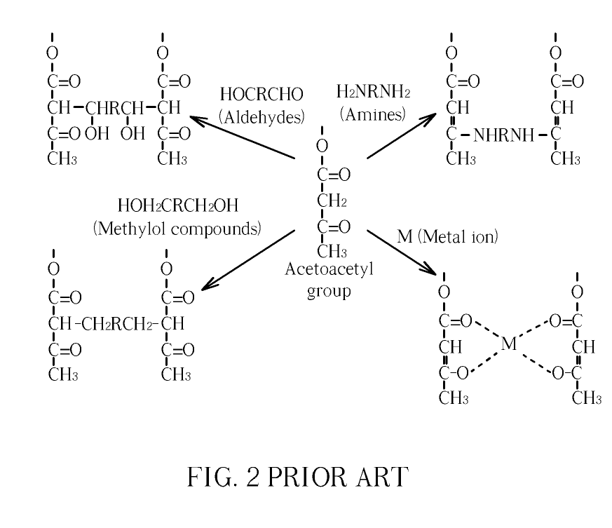

FIG. 3 shows a reaction of PVA and diketene; and

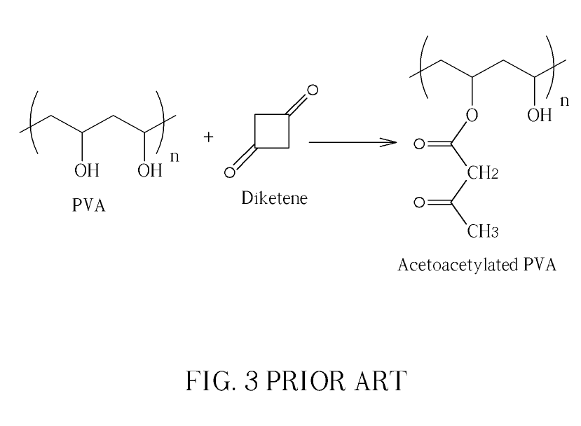

FIG. 4 shows possible structures of oxidized PVA in the method of the present invention.

### DETAILED DESCRIPTION

The inventor of the present invention diligently studied to invent a method to generate a three dimensional crosslinking structure among PVA molecular chains through directly forming a 1,3-diketone structure in the PVA (or a derivative thereof) molecular chain, without using an additional crosslinking agent, so as to improve the physical properties, such as water resistance, adhesive strength, and the like, of the PVA adhesive. The method of making an adhesive according to the present invention comprises steps of providing a PVA solution in water or a hydrophilic solvent and adding potassium permanganate (KMnO₄) to the PVA solution to allow the potassium permanganate to react under stirring.

PVA used in the method of the present invention includes PVA type polymers or copolymers, without particularly limitation of species or molecular weight, as long as the molecule has a 1,3-dihydroxyl structure. PVA polymers can be obtained from hydrolysis/saponification of vinyl ester polymers. The vinyl ester polymers before hydrolysis/saponification may be made from polymerization of a singular type of vinyl ester monomer or copolymerization of two or more different types of vinyl ester monomers, such as vinyl acetate, vinyl propionate, vinyl valerate, vinyl versatate, and the like. The degree of polymerization is not particularly limited. The ester functional groups of the polymerized vinyl ester polymer/copolymer are hydrolyzed (saponified) under an acidic or basic condition to form the PVA type polymer for use in the present invention. Hereinafter, the PVA type polymer is referred to as PVA. In the present invention, the molar fraction of the hydrolyzed ester functional groups of the vinyl ester polymer/copolymer with respect to PVA is not particularly limited and may be adjusted depending on the degree of polymerization of the polymer or the type of the adhesive desired. For example, in consideration of the solubility of PVA in water, the molar fraction of the hydrolysis of the ester functional groups are preferably between 90% and 100%, but not limited thereto.

Water or a hydrophilic solvent is preferred to serve as the solvent of the PVA solution. The hydrophilic solvent may be for example an organic solvent, such as methanol, ethanol, isopropanol, dimethyl sulfone, and the like. In further consideration of environmental pollution caused by organic solvents, water is preferred.

With respect to the dissolution of PVA, the PVA may be uniformly distributed in the water at room temperature followed by stirring, and may be further heated under stirring to dissolve. Alternatively, the PVA may be dissolved directly in hot water under stirring. The way of dissolution is not particularly limited as long as the PVA can be dissolved completely.

The concentration or weight percent of the PVA in the solution (that is, the solid content of the PVA solution) is not particularly limited and can be adjusted by the species, hydrolysis percentage of the ester functional groups, the polymerization degree of the polymer, and the desired uses (for example desired viscosity, water resistance, or adhesion). In consideration of the viscosity of the solution and the distribution of the oxidant used in next step, the solid content is preferably 1 to 20 weight percent (wt %), and more preferably 5 to 15 wt %.

In the present invention, after the PVA solution in water or a hydrophilic solvent is provided, potassium permanganate is added to the PVA solution and reacts with the 1,3-dihydroxyl groups on the PVA molecular chains under stirring to form 1,3-diketone structures.

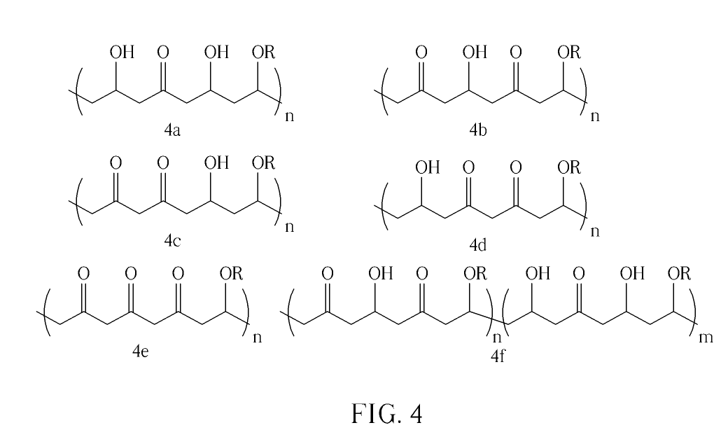

Potassium permanganate is used in the present invention. It is well known that potassium permanganate is an oxidant with a high oxidizing ability due to its high reduction potential (+1.49 volts). Potassium permanganate can react with a primary alcohol or a secondary alcohol under an acidic condition, to oxidize the secondary alcohol so as to form a ketone, or to oxidize the primary alcohol so as to form an aldehyde, which may be further oxidized to become a carboxylic acid. The hydroxyl groups on PVA molecular chains are secondary alcohol functional groups due to their location on the molecular chain. FIG. 4 shows some possible structures of PVA molecules after oxidized by potassium permanganate. In FIG. 4, a possible structure in the PVA molecular chain after oxidization is represented by a tetramethylene unit; however, it should be understood that the oxidation of the hydroxyl groups on the PVA molecular chains randomly takes place in the present invention. In other words, a structure in a PVA molecular chain after oxidization may be represented by formula 4a, 4b, 4c, 4d, 4e, or a combination thereof, such as formula 4f. Among these, the functional group, —OR, such as an acetoxy group (CH₃—C(═O)—O—), represents an ester functional group which may exist in the PVA molecule due to incomplete hydrolysis. The numbers n and m are positive integers representing the repeating numbers of the repeating units, which are in a conventional range without particular limitation. With respect to the structures represented by formulas 4a, 4b, 4c, 4d, and 4e, formula 4a is an example for the oxidation of a single hydroxyl group, formulas 4b, 4c, and 4d are examples for the oxidation of dihydroxyl groups, and formula 4e represents an example for the oxidation of a tri-hydroxyl group. Among these, formulas 4c, 4d, and 4e each have a 1,3-diketone structure as desired in the present invention, and such structure has a high reactivity to various functional groups due to a reaction of keto-enol tautomerism. Accordingly, they can serve as crosslinking sites on PVA molecular chains.

In the present invention, the reduction product of permanganate is manganous ion (Mn²⁺) which can attract (or chelate) the 1,3-diketone structure by electric force to form a three dimensional network structure among oxidized PVA polymers or copolymers, intramolecularly or intermolecularly. It should be noticed that, in the spirit and scope of the present invention, the useful oxidant is not limited to potassium permanganate. A metal-containing oxidant can be used in the present invention as long as it can oxidize 1,3-dihydroxyl groups of PVA molecular chains to form 1,3-diketone structures, and at the same time the metal ion produced from the reaction of the oxidant can combine with the 1,3-diketone structures formed on the PVA molecular chains to make the PVA molecular chains crosslink. Accordingly, the PVA polymer can be crosslinked without additionally using any crosslinking agent.

The potassium permanganate or other oxidant may be added in a form of powder or solution, as long as gelation of the PVA solution does not occur during the adding. For example, when potassium permanganate is added in a form of solution, the potassium permanganate powder may be dissolved in a little amount of water. Alternatively, the potassium permanganate powder may be dissolved in an inorganic acid (such as hydrochloric acid and sulfuric acid) aqueous solution, such that the inorganic acid and potassium permanganate are simultaneously added to the PVA solution under stirring and uniformly distributed in the solution.

The amount of potassium permanganate or other oxidant can be adjusted properly, depending on the solid content of the PVA solution, PVA species (due to chemical properties and reactivity), desired use (for example, the viscosity, water resistance, and adhesion properties of the desired adhesive), and chemical properties and the reactivity of the oxidant. If the amount is too much, the PVA solution will gelatinize quickly during the oxidation process; if the amount is too little, the 1,3-diketone structures generated in the oxidized PVA molecular chains are few. Taking potassium permanganate as an example, the weight percent of potassium permanganate based on PVA (that is, potassium permanganate weight/PVA weight×100%) is from 0.1% to 2%, preferably from 0.1% to 1%, and more preferably from 0.5% to 1%, to form an adhesive suitable for use in polarizing sheet manufacturing processes.

After adding potassium permanganate in the solution, potassium permanganate is allowed to react with PVA under stirring. The reaction is carried out under stirring to avoid aggregation or gelation of the reactants and/or the products and to facilitate a complete reaction. The stirring is preferably continued during the reaction to avoid local gelation or generation of colloid.

To accelerate the oxidation reaction and allow potassium permanganate to be completely reduced to form a manganous ion, the reaction solution may be heated. The temperature may be preferably 35 to 70° C., but not limited thereto, and may be adjusted depending on various polymer species. If the temperature is too high, potassium permanganate may react too fast with PVA on the instant of being added and thus local gelation of PVA will occur.

After potassium permanganate is added to the PVA solution, if potassium permanganate is not previously dissolved in an inorganic acid solution, an acid may be further added in the solution to facilitate the reaction of potassium permanganate. The useful acid may be for example hydrochloric acid, sulfuric acid, or other inorganic acid, as long as aggregation or gelation does not occur. The acid may be added to the PVA solution for acidification. Alternatively, the PVA may be allowed to be directly dissolved in an inorganic acid solution. The acidified PVA solution has a pH value of preferably 2 to 5, and more preferably 2 to 4.

Potassium permanganate is described in the above description as an example, but it should be noticed that other suitable oxidants also may be used.

A crosslinked PVA serving as an adhesive can be made without using additional crosslinking agents in the method of the present invention. However, after the adhesive is prepared, other crosslinking agents may be optionally added to the reacted solution for further improving the adhesion properties, such as adhesive strength or water resistance, of the adhesive. The crosslinking agents may be for example oxalaldehyde or glutaraldehyde.

Some examples are described hereinafter to detail the method of making an adhesive according to the present invention and a comparative example is described for comparison. The examples and the comparative example are for further detailed explanation and should not be construed for limiting the scope of the present invention.

### EXAMPLE

### Preparation Example

100 g of PVA powder was uniformly distributed in 900 g of water under stirring. The resulting mixture was heated at about 90 to 100° C. under stirring to dissolve the PVA powder. Subsequently, the resulting PVA aqueous solution was filtered with a 10 μm filter mesh or filter bag while being hot. The filtrate was stirred continuously until it was cooled to room temperature, and a 10 wt % PVA aqueous solution was obtained.

### Example 1

70 mg of KMnO₄ was dissolved in 10 ml of 1 N HCl aqueous solution and then added to 100 g of 10 wt % PVA aqueous solution (containing 10 g of PVA) as prepared in Preparation Example under stirring. The solution was continuously stirred for 2 hours, and the color was changed from violet to deep brown with brown particles appeared. The solution was stirred continuously and heated to about 40 to 50° C. As the brown particles disappeared and the solution gradually turned into a light yellow clear aqueous solution without any visible colloid, an adhesive was obtained.

### Example 2

70 mg of KMnO₄ was dissolved in 10 ml of water to form a KMnO₄ aqueous solution. 100 g of 10 wt % PVA aqueous solution (containing 10 g of PVA) as prepared in Preparation Example was heated to about 50 to 70° C. under stirring, and then the KMnO₄ aqueous solution was added thereto, resulting in a violet mixture. Thereafter, 2 ml of 1 N HCl aqueous solution was added to the mixture and stirred at a temperature of 50 to 70° C. for 30 minutes. As the solution exhibited light yellow and clarity without any visible colloid, an adhesive was obtained.

### Comparative Example 1

1.44 g of KMnO₄ was dissolved in 30 ml of water and then added to 100 g of 10 wt % PVA aqueous solution (containing 10 g of PVA) as prepared in Preparation Example under stirring. Thereafter, 2 ml of 1 N HCl aqueous solution was added to the PVA aqueous solution under stirring, and the PVA solution was found to be gelatinized, giving a deep brown/violet gel.

In view of Comparative Example 1, it can be known that KMnO₄ surely can oxidize the hydroxyl group of PVA and make the PVA molecular chains crosslink and be directly cured. In Examples 1 and 2, proper amounts of KMnO₄ were used respectively to conveniently obtain the clear adhesives without colloid, which are very suitably used for adhesion in polarizing sheet manufacturing processes.

Such adhesive/hydrogel made using the method of the present invention may be utilized in a common woodworking, such as making chipboards, particleboards, or fiberboards, in addition to polarizing sheet manufacturing processes. Alternatively, such adhesives may be utilized in common paper adhesion, such as serving as stationery glue. Furthermore, theoretically, such adhesives may be blended into pulp for making paper, thereby to improve the strength of the paper.

Those skilled in the art will readily observe that numerous modifications and alterations of the device and method may be made while retaining the teachings of the invention.

What is claimed is:

1. A method of making an adhesive, comprising steps of:
providing a polyvinyl alcohol (PVA) solution in water or a hydrophilic solvent; and
adding potassium permanganate to the PVA solution and allowing the potassium permanganate to react in a reaction under stirring.

2. The method of claim 1, wherein after potassium permanganate was added to the PVA solution, an acid was further added to the solution to facilitate the reaction of the potassium permanganate.

3. The method of claim 2, wherein the acid comprises hydrochloric acid or sulfuric acid.

4. The method of claim 1, wherein the PVA solution further comprises an acid to facilitate the reaction of the potassium permanganate.

5. The method of claim 4, wherein the acid comprises hydrochloric acid or sulfuric acid.

6. The method of claim 1, wherein the stirring is performed with proper heating.

7. The method of claim 2, wherein the stirring is performed with proper heating.

8. The method of claim 4, wherein the stirring is performed with proper heating.

9. The method of claim 1, wherein the polyvinyl alcohol in the solution has a concentration determined by a viscosity of the adhesive to be made.

10. The method of claim 1, wherein the potassium permanganate is added to the PVA solution in a form of aqueous solution and in an amount determined by a viscosity of the adhesive to be made without gelation.

11. The method of claim 10, wherein the potassium permanganate in a form of aqueous solution comprises an acid to facilitate the reaction of the potassium permanganate.

12. The method of claim 1, further comprises adding a crosslinking agent to the PVA solution.

13. A method of making an adhesive, comprising:
providing a polyvinyl alcohol (PVA) solution in water or a hydrophilic solvent; and
adding a metal-containing oxidant to the PVA solution and allowing the metal-containing oxidant to react in a reaction under stirring, wherein the metal-containing oxidant produces the metal ion in the reaction.

14. The method of claim 13, wherein after the metal-containing oxidant was added to the PVA solution, an acid was further added to the PVA solution to facilitate the reaction of the metal-containing oxidant.

15. The method of claim 14, wherein the acid comprises hydrochloric acid or sulfuric acid.

16. The method of claim 13, wherein the PVA solution further comprises an acid to facilitate the reaction of the metal-containing oxidant.

17. The method of claim 16, wherein the acid comprises hydrochloric acid or sulfuric acid.

18. The method of claim 13, wherein the stirring is performed with proper heating.

19. The method of claim 14, wherein the stirring is performed with proper heating.

20. The method of claim 16, wherein the stirring is performed with proper heating.

21. The method of claim 13, wherein the amount of the metal-containing oxidant and the amount of the polyvinyl alcohol are determined by a viscosity of the adhesive to be made.

22. The method of claim 13, further comprises adding a crosslinking agent to the PVA solution.

23. The method of claim 13, wherein, the metal-containing oxidant and the polyvinyl alcohol are respectively dissolved in water or hydrophilic solvents and mixed to start the reaction.

24. The method of claim 13, wherein the metal-containing oxidant comprises potassium permanganate.
